(19) United States
(12) Patent Application Publication
(10) Pub. No.: US 2010/0100605 A1
(43) Pub. Date: Apr. 22, 2010

(54) METHODS AND APPARATUS FOR MANAGEMENT OF INTER-WIDGET INTERACTIONS

(76) Inventors: Stewart O. Allen, Vienna, VA (US); Scott F. Cosby, Alexandria, VA (US); John A. Fath, Falls Church, VA (US); Matthew J. Keesan, Wahsington, DC (US); Richard S. Labarca, Bayport, NY (US); Hooman Radfar, Arlington, VA (US); Carlos F. Reverte, Arlington, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/560,127

(22) Filed: Sep. 15, 2009

Related U.S. Application Data
(60) Provisional application No. 61/097,094, filed on Sep. 15, 2008.
(60) Provisional application No. 61/097,098, filed on Sep. 15, 2008.

(51) Int. Cl. G06F 15/16

(52) U.S. Cl. 709/217; 709/227

(57) ABSTRACT

In one embodiment, a processor-readable medium storing code representing instructions to cause a processor to perform a process includes code to transmit using a communication channel a discovery signal from a first virally spread widget that has at least a portion executed at a content aggregation point to a second virally spread widget. The code also includes code to receive at the first virally spread widget a response signal sent from the second virally spread widget in response to the discovery signal.

### CROSS-REFERENCE TO RELATED PATENT APPLICATIONS

This patent application claims priority to and the benefit of U.S. Patent Application No. 61/097,094 entitled “Methods and Apparatus for Management of Inter-Widget Interactions” and filed on Sep. 15, 2008, which is incorporated herein by reference in its entirety.

This patent application is related to U.S. Patent Application No. 61/097,098, filed on Sep. 15, 2008, entitled “Methods and Apparatus related to Inter-Widget Interactions Managed by a Client-Side Master”, and related to co-pending U.S. Application bearing attorney docket no. CLEA-010/01US 307269-2024, filed on Sep. 15, 2009, entitled, “Methods and Apparatus related to Inter-Widget Interactions Managed by a Client-Side Master,” both of which are incorporated by reference herein in their entireties.

### BACKGROUND

Embodiments relate generally to the behavior of widgets, and, in particular, to methods and apparatus for management of inter-widget interactions.

The world wide web is a platform that has been used to exchange various forms of widgets including videos, images, text, music, applications, etc. Although various known methods of “viral” distribution have been developed to provide users with the capability to spread widgets to other users, these known methods have many shortcomings. For example, many known methods are limited in their ability to provide for the exchange of information between widgets and/or services associated with widgets. Thus, a need exists for methods and apparatus related to inter-widget interactions.

### SUMMARY

In one embodiment, a processor-readable medium storing code representing instructions to cause a processor to perform a process includes code to transmit using a communication channel a discovery signal from a first virally spread widget that has at least a portion executed at a content aggregation point to a second virally spread widget. The code also includes code to receive at the first virally spread widget a response signal sent from the second virally spread widget in response to the discovery signal.

### BRIEF DESCRIPTION OF THE DRAWINGS

FIG. 1 is a schematic block diagram that illustrates widgets configured to communicate via a communication channel established using a channel host, according to an embodiment.

FIG. 2 is a schematic block diagram that illustrates widgets configured to communicate with one another via a communication channel established at a content aggregation point associated with a network entity, according to an embodiment.

FIG. 3 is a schematic diagram that illustrates widgets configured to engage in inter-widget communication via a communication channel established at a content aggregation point associated with a network entity, according to an embodiment.

FIG. 4 is a flowchart that illustrates a method related to inter-widget signaling, according to an embodiment.

### DETAILED DESCRIPTION

Two or more widgets (e.g., a set of widgets) executing within one or more content aggregation points (CAPs) at one or more network entities can be configured to interact (e.g., communicate) with one another via a channel (e.g., a communication channel). Communication between the widgets can be referred to as inter-widget communication and can be performed via one or more signals transmitted between the widgets based on one or more protocols (e.g., Internet Protocol, a proprietary communications protocol). The signals transmitted by widgets during inter-widget communication can be referred to as inter-widget signals. In some embodiments, the inter-widget communication can be associated with an interactive session between the widgets such as a gaming session and/or a communication session (e.g., a chat session). A time period of inter-widget communication can be referred to as an inter-widget communication session.

In some embodiments, at least a portion of the communication channel can be established (and/or managed) within a network by a channel host. In some embodiments, the channel host can be a widget, a network entity (an application at the network entity), a content aggregation point, and/or a remote channel host within a network. In some embodiments, the communication channel can be established using a function served to one or more channel hosts (e.g., a widget), for example, in response to a request. In some embodiments, the communication channel can be referred to as a communication link. In some embodiments, the communication channel can operate as a bus (e.g., an ordered bus) or operate substantially similar to a bus.

One or more widgets can be served from a widget server to the content aggregation point for execution in response to a reference(s) to the widget(s) being accessed at the content aggregation point. The widget(s) can be virally spread to and/or placed at the content aggregation point(s). A widget(s) is virally spread when the widget is associated with (e.g., a reference to the widget is placed at, the widget is executed at) and/or configured to be associated with a content aggregation point in response to a sharing request associated with an instance of the widget at a different content aggregation point. More details related to viral sharing of widgets are set forth in co-pending U.S. application Ser. No. 11/537,362, filed on Sep. 29, 2006, entitled “Method and Apparatus for Widget-Container Hosting and Generation;” co-pending U.S. application Ser. No. 11/537,375, filed on Sep. 29, 2006, entitled “Method and Apparatus for Widget Container/Widget Tracking and Metadata Manipulation;” co-pending application No. 60/977,544, filed on Oct. 4, 2007, entitled “Method and Apparatus for Widget Sharing Between Content Aggregation Points;” and co-pending application Ser. No. 12/244,606, filed on Oct. 2, 2008, entitled “Method and Apparatus for Widget Sharing Between Content Aggregation Points;” all of which are incorporated herein by reference in their entireties.

At least a portion of the widgets and/or at least a portion of one or more functions (e.g., service modules, widget-container functions, applications) associated with the widgets can be executed within one or more content aggregation points at one or more network entities before the inter-widget communication commences. In other words, the widgets can communicate via inter-widget signaling while executing within one or more content aggregation points at one or more network entities. In some embodiments, a widget can be configured to invoke various functions (e.g., service modules, widget-container functions) after being served to the widget and/or can invoke various functions (which can reside at a host (e.g., a widget sharing host)) via an application programming interface (API). In some embodiments, one or more portions of the function(s) can be referred to as a kernel.

The widgets can be configured to transmit (e.g., exchange), via inter-widget communication, information that can be used, for example, to cause an action related to a widget (e.g., modification of execution of one or more of the widgets and/or one or more service modules associated with the widgets). In some embodiments, one or more of the widgets can be configured to use inter-widget signaling to request and/or transmit (e.g., send, broadcast) an indicator related to the availability/functionality to engage in inter-widget communication.

In some embodiments, one or more portions of inter-widget communication between widgets and/or resulting behavioral changes (e.g., triggered actions) of the widget(s) can be tracked (e.g., collected, stored, processed, and/or transmitted). In other words, information related to one or more portions of inter-widget communication between widgets can be tracked. In some embodiments, a user-triggered interaction with a widget (e.g., an interaction of a user (via a user interface) with a widget) can also be tracked. The tracked inter-widget communication parameter values (e.g., inter-widget communication parameter values related to user-triggered interactions) can be, for example, processed to identify one or more trends related to the inter-widget communication and/or to cause an action (e.g., a behavioral change) related to a widget. The data that is collected, stored, and/or processed can be referred to as tracking data or as inter-widget tracking data (when specifically related to an inter-widget interaction).

During an inter-widget communication session between widgets, a single widget from the widgets can be selected to operate as (e.g., function as) a master while executing at a client rather than an application at, for example, a server operating as a master. The widget selected as the master can be referred to as a client-side master widget or as a master widget. The widget can be selected as the master based on one or more conditions. The master widget can be configured to manage one or more portions (e.g., application level signaling between member widgets) of an inter-widget communication session while a channel host can be configured to manage other portions (e.g., network level signaling related to the logistics of a communication channel) associated with the inter-widget communication session. The master widget can be configured to, for example, manage a global state of the inter-widget communication session and/or can order the exchange of content of inter-widget signals (from member widgets) within the inter-widget communication session. In some embodiments, multiple widgets can share, or individually execute, at least a portion of one or more functions of a master widget. More details related to client-side master widgets are set forth in co-pending application No. 61/097,098, filed on Sep. 15, 2008, entitled “Methods and Apparatus Related to Inter-Widget Communication Managed by a Client-Side Master,” and co-pending U.S. Application bearing attorney docket no. CLEA-010/01US 307269-2024, filed on Sep. 15, 2009, entitled, “Methods and Apparatus related to Inter-Widget Interactions Managed by a Client-Side Master,” both of which are incorporated herein by reference in their entireties.

Each of the widgets can be any type of object such as a static data object (e.g., a text-based object), a media object (e.g., a video, an mp3, or an image), and/or a software object (e.g., a javascript applet, a rich media object) that can be executed (e.g., displayed, manipulated) at a content aggregation point associated with, for example, a network entity. The network entity can be a wired device and/or a wireless device such as, for example, a computer (e.g., a computing device), a mobile phone, a personal digital assistant (PDA), and/or a server. The network entity can be configured with one or more platforms that can include on one or more types of hardware, architecture, software, operating systems, runtime libraries, and so forth.

A content aggregation point can be, for example, managed by (e.g., hosted at, served from) and/or executed at the network entity and can be, for example, a desktop, a start page, a wireless application protocol (WAP) gallery, a gallery, a processor-readable vehicle (e.g., a webpage), a portal, and/or a directory. A network entity configured to manage a content aggregation point can be referred to as a content aggregation point server. WAP galleries, web galleries, and so forth are types of content aggregation points that can be referred to as content distribution points. In some embodiments, a content aggregation point can be referred to as a content aggregation location or as a content aggregation site.

In some embodiments, a widget can be associated with (e.g., contained in, integrated in, referenced within) a widget container (also can be referred to as a container) when, for example, shared with (e.g., placed at) a content aggregation point. The widget container can be framework that can include a reference to the widget and can include a service module (e.g., tracking service module, advertisement service module, etc.). More details related to placement of a widget container and/or a widget at a content aggregation point are set forth in co-pending application Ser. No. 11/682,626, entitled, “Method and Apparatus for Widget and Widget-Container Platform Adaptation and Distribution,” which is incorporated herein by reference in its entirety.

In this written description and the appended claims, the singular forms “a,” “an” and “the” include plural referents unless the context clearly dictates otherwise. Thus, for example, the term “an identifier” is intended to mean a single identifier or a combination of identifiers. In addition, the term “widget,” which is used throughout the written description and the appended claims, can also mean an “instance of a widget.” For example, a widget that is served to a content aggregation point can be an instance of the widget served to the content aggregation point.

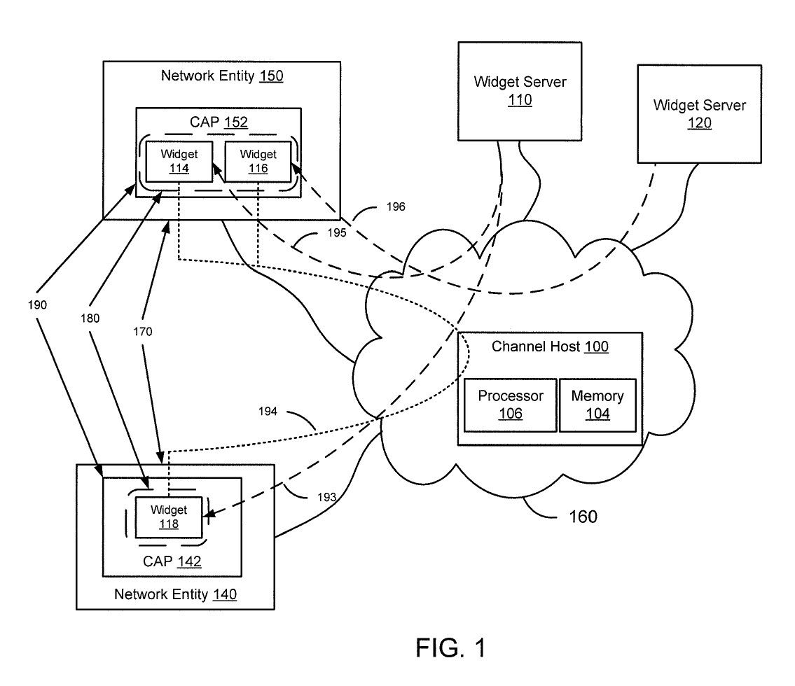

FIG. 1 is a schematic block diagram that illustrates widgets 180 configured to communicate via a communication channel 194 established using a channel host 100, according to an embodiment. Specifically, the widgets 180 (e.g., set of widgets 180) includes widget 114, widget 116, and widget 118. At least a portion of widget 114 and widget 116 are executing at content aggregation point 152 at network entity 150, and at least a portion of widget 118 is executing at content aggregation point 142 at network entity 140. The network entity 140 and/or network entity 150 can have a memory (not shown) and/or a processor (not shown) and can be, for example, a computing device (e.g., a personal computer) and/or a wireless device (e.g., a PDA). The content aggregation point 142 and the content aggregation point 152 can collectively be referred to as content aggregation points 190. The network entity 150 and the network entity 140 can collectively be referred to as network entities 170.

Widget 114 and widget 118 are served to content aggregation point 152 and content aggregation point 142, respectively, from widget server 110. Widget 116 is served to content aggregation point 152 from widget server 120. Each widget from the widgets 180 can be served in response to a request defined in response to a reference (not shown) to, for example, the widget being accessed at the content aggregation point. In some embodiments, the reference can also be referred to as a link. For example, widget 114 can be served to network entity 150 for execution within content aggregation point 152 in response to a reference to widget 114 being accessed at content aggregation point 152. In some embodiments, reference can be automatically accessed when a portion of content aggregation point 152 is accessed. In some embodiments, the reference can be accessed in response to, for example, a user-triggered interaction via a user-interface (not shown) associated with the network entity 150.

The communication channel 194 can be established within network 160, which can include one or more wired and/or wireless segments, using channel host 100. After the communication channel 194 has been established, one or more of the widgets 180 can be configured to transmit one or more signals related to inter-widget communication to another of the widgets 180 via the communication channel 194. In some embodiments, the communication channel 194 can be established based on an available channel and/or a channel that has been reserved (e.g., a pre-determined channel) for use by each widget from the widgets 180. Although not shown, in some embodiments, the channel host can be one of the widget 180, one of the network entities 170, one of the content aggregation points 180, and/or a different remote channel host within the network 160.

In some embodiments, the communication channel 194 can be established using a channel selected by the channel host 100. The channel host 100 can communicate the selected channel to one or more of the widgets 180 using, for example, a notification message. In some embodiments, the communication channel 194 can be established in an ad-hoc fashion. For example, in response to a query (e.g., a channel request) for an available channel, the channel host 100 can send an identifier for an available channel for communication to one or more of the widgets 180. The query can be initiated by any of the widgets 180 (e.g., a widget 114).

In some embodiments, one or more users associated with a network entity (e.g., network entity 150) can select a channel that can be used for inter-widget communication, and can communicate the selection via, for example, an out-of-band communication message (e.g., an e-mail message, a message sent via a different communication channel). The user can define one or more parameter values (e.g., a port value, a time value) for establishing the communication channel 194.

In some embodiments, once the communication channel 194 has been established (established in response to a request from any widget from the widgets 180), one or more of the widgets 180 can be invited to join the communication channel 194. In other words, the widget(s) from the widgets 180 can be configured to receive a request to join the communication channel 194. In response to the invitation, one or more of the widgets 180 can be configured to join the communication channel 194. In some embodiments, widgets can receive and respond to invitations to join the communication channel 194 using an out-of-band messaging mechanism (e.g., a different communication channel) and/or via the messages exchanged with the channel host 100.

In some embodiments, the communication channel can be left open or terminated (e.g., immediately terminated, terminated after a specified period of time) after an inter-widget communication session is over. In some embodiments, an inter-widget communication session can commence when the communication channel 194 is established and can end when the communication channel 194 is terminated. In some embodiments, an inter-widget communication session can include a period of time when one or more of the widgets 180 are exchanging information via the communication channel 194.

One or more inter-widget signals can be transmitted between one or more of the widgets 180 to communicate (e.g., send, declare, request, acknowledge) information related to the presence of and/or related to a function (e.g., a capability associated with a function, a set of parameters that can be handled by a portion of a function) associated at least one of the widgets 180. In some embodiments, inter-widget signals can be referred to as inter-widget messages. Information related to presence can include, for example, existence of a widget, a status and/or a state of a widget, and so forth. In some embodiments, the status can be a status with respect to inter-widget communication and can be, for example, an available status, a suspended status (e.g., a paused status), a predicted available status, and/or an unavailable status. The functionality can be related to, for example, input parameter values that can be handled by (e.g., processed by) a function associated with the widget, output parameter values that can be handled by (e.g., produced by) a function associated with the widget, a specified behavior of the widget (e.g., an execution of the widget, a sequence of actions performed by the widget), and so forth. In some embodiments, one or more of the widgets 180 can be configured to transmit (e.g., automatically transmit) and/or respond (e.g., automatically respond) to inter-widget signals related to presence and/or functionality in a widget auto-discovery process.

For example, an inter-widget signal can be sent (e.g., transmitted, broadcast) from widget 114 to widget 116 and/or to widget 118 to make widget 116 and/or widget 118 aware of the presence of widget 114 and/or a functionality associated with widget 114. In other words, the widget 114 can be configured to declare (e.g., send) information related to functionality and/or presence. In some embodiments, an inter-widget signal can be sent from widget 114 to widget 116 to request information related to the presence (e.g., status) of widget 116 and/or a functionality associated with widget 116. Inter-widget signals related to declaration of and/or request for information about presence and/or functionality can be referred to as discovery signals.

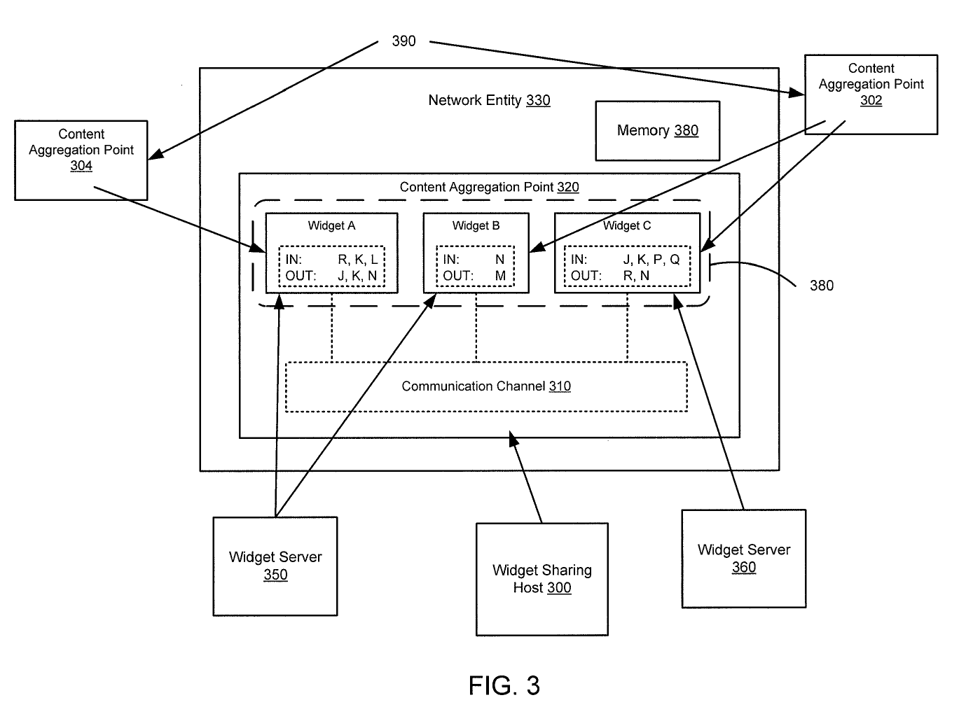

In response to a discovery signal from widget 114, for example, widget 116 and/or widget 118, can send an inter-widget signal to acknowledge the information transmitted from widget 114. In some embodiments, an inter-widget signal can be sent from one or more of the widgets 180, for example, to acknowledge (e.g., confirm) a particular status or to block/prevent inter-widget communication. Responses to discovery signals can be referred to as a response signals. More details related to discovery of functionality related to widgets are discussed in connection with FIG. 3.

In some embodiments, an inter-widget signal can be used to, for example, communicate data such as user-triggered parameter values, input parameter values, and/or an output parameter values between the widgets 180. These types of inter-widget signals can be referred to as data signals. In some embodiments, one or more of the widgets 180 can be configured to send an inter-widget signal to, for example, trigger an action by another of the widgets 180. These types of inter-widget signals can be referred to as command signals. The inter-widget signaling can be defined based on, for example, a known protocol such as Internet Protocol (IP) and/or a proprietary signaling protocol. Inter-widget signal types, in addition to those described herein, can be exchanged between the widgets 180.

In some embodiments, at least a portion of an inter-widget communication session (e.g., inter-widget signaling, application level signaling) via the communication channel 194 can be managed by a client-side master widget. Details related to inter-widget communication related to client-side master widgets are set forth in co-pending application No. 61/097,098, filed on Sep. 15, 2008, entitled “Methods and Apparatus Related to Inter-Widget Communication Managed by a Client-Side Master,” and co-pending U.S. Application bearing attorney docket no. CLEA-010/01US 307269-2024, filed on Sep. 15, 2009, entitled, “Methods and Apparatus related to Inter-Widget Interactions Managed by a Client-Side Master,” both of which are incorporated herein by reference in their entireties.

In some embodiments, the widgets 180 can be configured to exchange inter-widget signals despite being configured to operate (e.g., execute, communicate) based on different protocols, platforms, and so forth. For example, the widgets 180 can be programmed based on different platforms that are not compatible with one another. However, the widgets 180 can be configured to define and exchange at least inter-widget signals based on a common inter-widget signaling protocol.

In some embodiments, one of the widgets 180 operating based on a platform can be configured to access (e.g., invoke via an API, request and receive) a translation function (not shown) that the can be used by the widget when engaging in an inter-widget communication session with another widget 180 that is configured to operate based on a different platform. For example, widget 118 can be configured to process (e.g., produce) inter-widget signals based on a first protocol that is incompatible with a second protocol used by widget 116. Widget 118 can be configured to access a translation function to translate inter-widget signals produced by widget 118 based on the first protocol into inter-widget signals based on the second protocol so that the inter-widget signals will be compatible with widget 116. Widget 118 can also be configured to invoke the translation function to translate inter-widget signals produced by widget 116 and based on the second protocol into inter-widget signals that can be compatibly processed by widget 118.

In some embodiments, one or more widgets 180 operating based on different platforms can be configured to negotiate a particular platform that can be used for an inter-widget interaction (e.g., during an inter-widget communication session). In some embodiments, the platform (e.g., communication protocol) can be selected by the channel host 100. Although not shown, in some embodiments, the translation function can be configured to access, for example, a database (e.g., a local database, a remote database) with information (e.g., algorithms, look-up tables) that can be used to translate inter-widget interactions between various widget platforms.

Inter-widget signals can be transmitted before and/or after the communication channel 194 has been established. In some embodiments, for example, after widgets 180 have already engaged in inter-widget communication via communication channel 194, inter-widget signals can be transmitted between the widgets 180 so that one or more widgets from the widgets 180 can discover and/or declare a function (or a portion of a function) associated with one or more different widgets from the widgets 180. In some embodiments, an inter-widget signal can be sent to a specific widget (or subset of widgets) and/or can be broadcast within network 160. Inter-widget signaling after the communication channel 194 has been established can be transmitted using the communication channel 194 and/or can be transmitted via an out-of-band communication link.

In some embodiments, one or more portions of an inter-widget signal can be queued for a period of time. For example, if widget 114 is unable to respond to an inter-widget signal (e.g., an inter-widget signal defining a request related to the availability/functionality of widget 114 to engage in inter-widget communication), the inter-widget signal can be queued and transmitted to widget 114 when widget 114 becomes available to respond (in response to an indicator). In some embodiments, if widget 118 had sent the inter-widget signal to widget 114, widget 118 can be triggered to resend the inter-widget signal when widget 114 is available to respond (e.g., triggered by a master of the inter-widget communication session such as a client-side master widget or the channel host 100). In some embodiments, the inter-widget signal can be queued for a specified period of time. The inter-widget signal can be purged if widget 114 does not become available before a specified period of time has expired. In some embodiments, the queuing of the inter-widget signal can be handled by a queuing entity. The queuing entity can be, for example, any widget (e.g., widget 116), the channel host 100, and/or a master of an inter-widget communication session associated with the communication channel 194 (e.g., a master widget, the channel host 100).

In some embodiments, one or more of the widgets 180 can subscribe to receive information (e.g., a notification, data) related to an event related to another widget 180. In some embodiments, the event can be an action, an update, a current event, a future event, a subset of events. In some embodiments, for example, widget 116 can request that widget 116 be notified when widget 118 has acquired a particular (or type of) functionality, has calculated a particular (or type of) output parameter value, is ready to receive a particular (or type of) input parameter value, and/or is available to engage in inter-widget communication. In some embodiments, the subscription can be managed by a subscription function associated with an entity (e.g., widget 116, widget 118, a different widget (e.g., widget 116), the channel host 100, and/or a master of an inter-widget communication session associated with the communication channel 194 (e.g., a master widget, the channel host 100)).

One or more of the widgets 180 can be configured to discover (via inter-widget signaling) another of the widgets 180 (or a function associated with a widget) even though one or more of the widgets 180 may be executing independent of one another. One or more of the widgets 180 may operate independently when, for example, they are served to one or more content aggregation points 190 at different times, are controlled by different entities, operate based on different platforms, are not aware of one another before being served, and/or are not specifically configured to operate together (e.g., operate in concert) as applications that are dependent on one another (except for via inter-widget communication and/or an API related to inter-widget communication). For example, even though widget 114 and widget 116 are both configured to execute within content aggregation point 152, widget 114 and widget 116 can be independently functioning widgets that are served from different widget servers—widget server 110 and widget server 120, respectively.

In some embodiments, the channel host 100 can be configured to process (e.g., store, use) information related to inter-widget communication. For example, the channel host 100 can store a status of and/or information related to one or more functions associated with one or more widgets within network 160. In other words, the channel host 100 can track (e.g., actively/passively collect and store) which of the widgets 180 have been served to the content aggregation points 190 and can store status and/or functionality information related to the widgets 180 for inter-widget communication. In other words, the channel host 100 can be configured to register presence and/or functionality information related to the widgets 180 to facilitate inter-widget communication. In some embodiments, the registered information can be made available (through access controls) to one or more of the widgets 180. The channel host 100 can be configured to use that information to initiate, receive, and/or respond to one or more inter-widget signals.

For example, an inter-widget signal that includes a query related to the presence of another widget can be broadcast from widget 114 over network 160. An individual widget such as widget 116 can respond to the query with an indicator that widget 116 is available for inter-widget communication, or channel host 100 (which can be aware of the status of one or more widgets within network 160) can respond to the inter-widget signal with an indicator that widget 116 is available for inter-widget communication. In some embodiments, the inter-widget signal can be sent to the channel host 100 and/or to the widgets 180 (e.g., a subset of the widgets 180). More details related to discovery of widgets and with respect to storage of information related to inter-widget communication are discussed in connection with FIG. 3.

As shown in FIG. 1, the channel host 100 has a processor 106 and a memory 104. The processor 106 and/or the memory 104 can be used to perform functions related to the communication channel 194. For example, the memory 104 can be used to store information related to establishing the communication channel 194 and/or information related to inter-widget signaling between the widgets 180.

In some embodiments, one or more functions related to inter-widget communication (e.g., a function related to establishing/terminating a communication channel, a function related to inter-widget signaling) can be programmed into and/or associated with one or more of the widgets 180. For example, the function(s) can be included as part of a widget application and/or included in a container and/or a service module associated with the widget. In some embodiments, the function(s) can be invoked via an API. More details related to containers, service modules, and APIs of widgets are described in connection with co-pending U.S. application Ser. No. 11/537,362, filed on Sep. 29, 2006, entitled “Method and Apparatus for Widget-Container Hosting and Generation;” co-pending U.S. application Ser. No. 11/537,375, filed on Sep. 29, 2006, entitled “Method and Apparatus for Widget Container/Widget Tracking and Metadata Manipulation;” co-pending application No. 60/977,544, filed on Oct. 4, 2007, entitled “Method and Apparatus for Widget Sharing Between Content Aggregation Points;” and co-pending application Ser. No. 12/244,606, filed on Oct. 2, 2008, entitled “Method and Apparatus for Widget Sharing Between Content Aggregation Points;” all of which are incorporated herein by reference in their entireties.

In some embodiments, one or more functions related to inter-widget communication can be served to one or more widgets 180, one or more network entities 170 (e.g., network entity 150), and/or one or more of the content aggregations points 190. In some embodiments, the function(s) can be delivered to a location (e.g., network entity 150, content aggregation point 152, and/or widget 114) where the function(s) can be invoked (e.g., accessed), for example, via an API associated with the function(s). In addition, the function can be invoked by the one or more of the widgets 180, one or more of the network entities 170, and/or one or more of the content aggregation points 190. For example, content aggregation point 152 (such as a web browser) can be configured to receive and execute a function (e.g., a network level signaling function) related to sending and/or receiving messages via the communication channel 194. In some embodiments, the function(s) can be served to, for example, content aggregation point 152, network entity 150, and/or widget 114 where the function can be invoked by the content aggregation point 152, network entity 150, and/or widget 114.

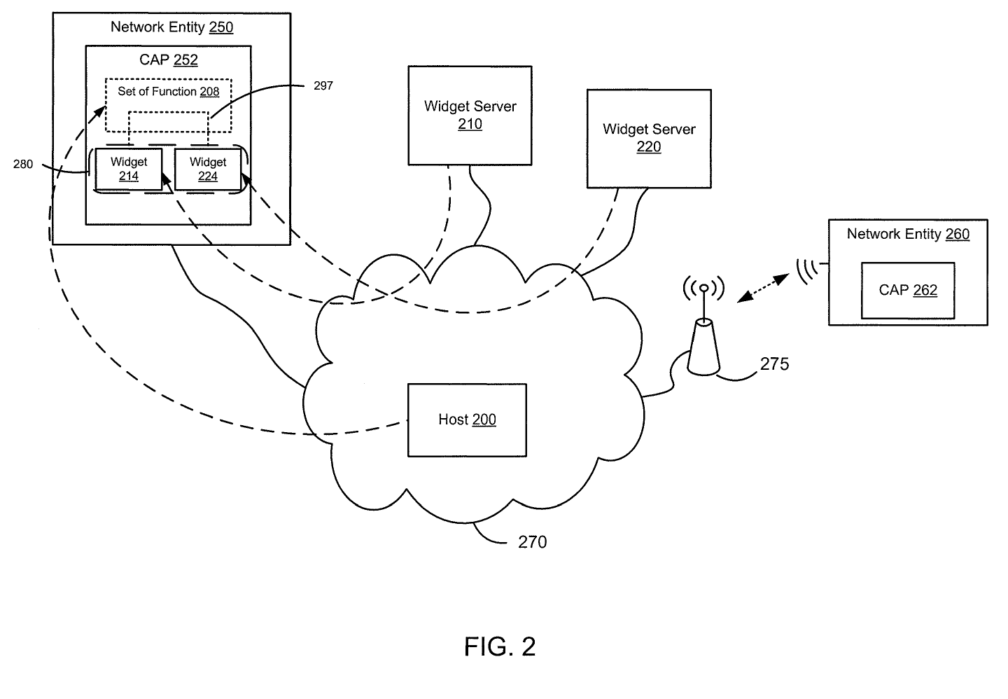

In some embodiments, the function(s) can be fetched (e.g., requested) by one or more widgets 180, one or more content aggregation points 190, and/or one or more network entities 170 before the function(s) is needed. For example, a function related to communicating via communication channel 194 can be fetched by widget 114 substantially immediately before, or a specified time period before the widget 114 attempts to transmit at least a portion of, for example, an inter-widget signal via the communication channel 194. In some embodiments, a function(s) can be served in response to at least a portion of a widget from the widgets 180 being executed at one or more of the content aggregation points 190. More details related to functions being served to widgets are described in connection with FIG. 2.

In some embodiments, the functions related to inter-widget communication can reside at (e.g., be stored at, programmed into) one or more widgets 180, one or more content aggregation points 190, and/or one or more network entities 170. For example, a function associated with inter-widget signaling can be included as part of an application of a widget from the widgets 180. In some embodiments, the function can be associated with one or more of the widgets 180 invoked via an API associated with the function.

Inter-widget communication via communication channel 194 can be used to modify the behavior of one or more of the widgets 180. For example, information requested from widget 114 by widget 116 can be sent to widget 116 and can be used by widget 116 to change the execution of widget 116. The change can be determined based on one or more conditions associated with widget 116. Specifically, widget 116 can be configured to display a particular advertisement or execute a particular algorithm based on information related to a user-triggered interaction with widget 114. More details related to modification of behavior of a widget based on information exchanged during an inter-widget communication session are described in connection with FIG. 3.

In some embodiments, the channel host 100 can be configured to track one or more portions of an inter-widget communication session (e.g., an interactive inter-widget communication session) associated with the communication channel 194. As the host of the communication channel 194, the channel host 100 can be configured to manage network level signaling (e.g., manage distribution/logistics of signals) associated with the communication channel 194. Accordingly, the channel host can receive signals (e.g., inter-widget signals) transmitted via the communication channel 194. The channel host 100 can be configured to collect and/or store specified information related to the communication channel 194. The information related to the communication channel 194 can be stored as tracking data. For example, the channel host 100 can be configured to track (e.g., collect and store) the number, content, and/or type of inter-widget signals (e.g., save signals, get signals, query signals, command signals) transmitted by one or more of the widgets 180, user interactions with one or more of the widgets 180, attributes (e.g., type, content, timing, and/or number) of actions of one of the widgets 180 triggered (e.g., caused) by another of the widgets 180, characteristics related to the communication channel 194 (e.g., a duration of the inter-widget communication session, a date-time stamp associated with the inter-widget communication channel), and/or the types of widgets 180 involved in the inter-widget communication session.

In some embodiments, one or more of the widgets 180, for example, can be configured to trigger the channel host 100 to collect and/or store specified information related to an inter-widget communication session associated with the communication channel 194 (e.g., information related to widget 116). For example, widget 114 can be configured to trigger channel host 100 to track a number of inter-widget signals (e.g., save signals/messages) transmitted between widget 114 and widget 116. In some embodiments, the channel host 100 can be triggered (e.g., triggered by one of the widgets 180) to collect and/or store information related to behavioral changes of one or more of the widgets 180.

Although not shown, in some embodiments, a different entity such as one or more of the network entities 170, the content aggregation points 190, and/or the widgets 180 can be configured to collect and/or store information related to an inter-widget communication session associated with the communication channel 194. For example, widget 114 can be configured to collect and/or store information related to content sent from widget 114 and/or received from widget 118. In some embodiments, content aggregation point 152 can be configured to collect and/or store information related to execution of widget 114 and/or widget 116. In some embodiments, network entity 140 can be configured to collect and/or store information related to inter-widget signaling associated with widget 118.

In some embodiments, information related to an inter-widget communication session that is collected and/or stored by the network entities 170, the content aggregation points 190, and/or the widgets 180 can be sent to a different entity for storage and/or further processing. In some embodiments, the information can be transmitted using, for example, one or more packets (e.g., packet bursts, regularly scheduled packets). The information can be sent to, for example, the channel host 100, a widget server (e.g., widget server 110), and/or a different computing entity (not shown) for storage and/or further processing. In some embodiments, the information can be transmitted via the communication channel 194. In some embodiments, the information related to an inter-widget communication session (e.g., tracked data) can be processed using the apparatus and methods set forth in co-pending application Ser. No. 61/089,357, entitled, “Methods and Apparatus for Processing Data to Produce a Data Tree,” which is incorporated by reference herein in its entirety.

In some embodiments, information that is tracked during (or after) an inter-widget communication session can be used to modify the behavior of one or more of the widgets 180. For example, information related to messages transmitted between widget 116 and widget 118 can be used to modify the behavior of widget 114. For example, widget 114 can execute in a different fashion based on an inter-widget signaling trend between widget 116 and widget 118. Specifically, widget 114 can be configured to display a particular advertisement/content or execute a particular algorithm based on the content of inter-widget signals transmitted between widget 116 and widget 118 during a current or terminated inter-widget communication session.

Although FIG. 1 is related to inter-widget communication via communication channel 194, which is a communication channel established using channel host 100, the embodiments described in connection with FIG. 1 can be applied in connection with a different communication channel configuration. For example, the embodiments described in connection with FIG. 1 can be applied within a communication channel established exclusively at a network entity (e.g., a communication channel established using a function associated with a content aggregation point).

FIG. 2 is a schematic block diagram that illustrates widgets 280 configured to communicate with one another via a communication channel 297 established at a content aggregation point 252 associated with a network entity 250, according to an embodiment. The widgets 280 include widget 214, which is served to content aggregation point 252 from widget server 210, and widget 224, which is served to content aggregation point 252 from widget server 220. A set of functions 208 is served to the content aggregation point 252 from a host 200 (e.g., a widget sharing host) within network 270. Specifically, the set of functions 208 is served to the network entity 250 so that the set of functions 208 can be used (e.g., controlled, accessed) by various applications at the network entity 250 such as content aggregation point 252. In some embodiments, the set of functions 208 can be referred to as a library of functions. In some embodiments, one or more portions of the set of functions 208 can be referred to as a kernel.

In this embodiment, the set of functions 208 includes multiple functions related to inter-widget communication. Specifically, the set of functions 208 includes one or more functions used by the content aggregation point 252, as well as the widgets 280, to establish the communication channel 297. These functions can be referred to as communication channel functions. The set of functions 208 can also include one or more functions that can be used by the widgets 280 to communicate via the communication channel 297. For example, the set of functions 208 can include one or more functions related to inter-widget signaling. These functions can be referred to as inter-widget signaling functions.

In some embodiments, the set of functions 208 can include various functions (such as service module functions) that can be invoked by the network entity 250, the content aggregation point 252, widget 214 and/or widget 224. For example, the set of functions 208 can include a metadata searching/retrieval function, a polling/categorizing function, a deployment function (e.g., using a placement service module), a transaction service function (e.g., a service module for facilitating a web purchase, a service module used for signing a user up for a web service, etc.), a security function (e.g., security firewall function), a tracking function, a referral service function (e.g., a function used to refer a viewer to a widget), an advertisement function, and/or a directory function (e.g., a function used for searching in a directory).

In this embodiment, the set of functions 208 is served to content aggregation point 252 in response to widget 214 and/or widget 224 being served to the content aggregation point 252. For example, widget 214 can be configured to trigger loading of the set of functions 208 when execution of at least a portion of widget 214 has commenced. In some embodiments, for example, one or more portions of the set of functions 208 can be requested by the content aggregation point 252 in response to at least a portion of widget 214 being executed at the content aggregation point 252. In some embodiments, a portion of the set of functions 208 can be served to content aggregation point 252 in response to a user-triggered interaction with one of the widgets 280, the network entity 250, and/or the content aggregation point 252.

In some embodiments, access to one or more functions from the set of functions 208 can be restricted. For example, the set of functions 208 can be configured so that only widget 214 can access a portion of the set of functions 208 and widgets 224 can access a different portion of the set of functions 208. In some embodiments, a different set of functions (not shown) can be served to the network entity 250 for use specifically by widget 214 and/or widget 224. In some embodiments, one or more portions of the set of functions 208 can be invoked (e.g., accessed), for example, via an API associated with the portion(s).

FIG. 3 is a schematic diagram that illustrates widgets 380 configured to engage in inter-widget communication via a communication channel 310 established at content aggregation point 320 associated with a network entity 330, according to an embodiment. At least a portion of widget A, widget B, and widget C (which can be collectively referred to as widgets 380) are executing within content aggregation point 320. Widget C is served for execution within content aggregation point 320 from widget server 360. Specifically, an instance of widget C can be served from widget server 360 for execution within content aggregation point 320 in response to a reference (not shown) to widget C being accessed at content aggregation point 320. In some embodiments, the reference can be automatically accessed when a portion of content aggregation point 320 is executed and/or accessed in response to a user-triggered interaction with the reference. Likewise, widget A and widget B are served for execution within content aggregation point 320 from widget server 350.

As indicated in FIG. 3, widget A has been shared (e.g., virally shared) from content aggregation point 304. Specifically, a reference to widget A has been placed at content aggregation point 320 in response to a sharing request associated with (e.g., initiated at) an instance of widget A executing at content aggregation point 304. Likewise, widget B and widget C have been shared with content aggregation point 320 from content aggregation point 302.

The communication channel 310 through which the widgets 380 engage in inter-widget communication is established at content aggregation point 320 associated with network entity 330. In this embodiment, the content aggregation point 320 is functioning as a host of the communication channel 310. The communication channel 310 can be established in response to a request from one or more of the widgets 380. The communication channel 310 can be established based on a communication channel function served to the content aggregation point 320 and/or based on a communication channel function integrated into (e.g., programmed within) the content aggregation point 320.

Each of the widgets 380 is configured to receive (and/or process) specified input parameters (shown as “IN” parameters) and produce (e.g., define) specified output parameters (shown as “OUT” parameters) based on one or more functions associated with the widgets (e.g., a function programmed into the widget, a function served to the widget in response to a request from the widget, a function accessed by the widget via an API). In some embodiments, the parameters can also be referred to as information types. In this embodiment, widget A is configured to receive one or more values for input parameters R, K, and L, and is configured to produce (e.g., define) one or more values for output parameters J, K, and N. Widget B is configured to receive one or more values for input parameter N, and is configured to produce one or more values for output parameter M. Widget C is configured to receive one or more values for input parameters J, K, P, and Q, and is configured to produce one or more values for output parameters R and N. In some embodiments, a value of an output parameter can be referred to as a result and a value of an input parameter can be referred to as an operand.

As shown in FIG. 3, the widgets 380 are each configured to produce different sets of output parameter values and are configured to receive different sets of input parameter values. In some embodiments, one or more of the widgets 380 can be configured to receive different or the same (or similar) input parameter values and/or can be configured to produce different or the same (or similar) output parameter values. In some embodiments, one or more input/output parameter values can be translated by one or more widgets 380 using a translation function before the input/output parameters value(s) are communicated to another of the widgets 380.

Each of the widgets 380 can be configured to produce (e.g., define) one or more values for the output parameters based on one or more values of the input parameters. The input parameter values and/or the output parameter values (can be referred to as input/output parameter values) can be related to any function associated with any of the widgets 380. The input and/or output parameter values can be transmitted, via the communication channel 310, from one widget to another widget from the widgets 380 using inter-widget signals (e.g., inter-widget data signals). For example, widget C can be configured to receive a value for input parameter J, which is an output parameter for widget A, from widget A using an inter-widget signal over the communication channel 310. Specifically, widget A can be configured to produce a map coordinate (which can be an output parameter value) based on a street address (which can be received as one or more of the input parameter values). In some embodiments, for example, widget A can be configured to calculate a cost estimate for purchasing a product (which can be output as an output parameter value).

In some embodiments, an input parameter value(s) and/or an output parameter value(s) can be displayed or used to produce an image on a display (not shown) associated with the network entity 330. For example, map coordinates produced as an output parameter value by widget B can be used to produce an image of a map on a display associated with the network entity 330. In some embodiments, an input parameter value(s) and/or an output parameter value(s) can be stored in a memory 380 associated with the network entity 330 and/or transmitted via a network (not shown) to, for example, a different network entity (not shown).

In some embodiments, the input parameter values and/or the output parameter values can be produced in response to a user-triggered interaction (e.g., a user input). For example, a user may transmit (e.g., trigger transmission of) values for input parameters J, K, and P to widget C, for example, via a user interface (not shown). Widget C can use one or more of these input parameter values to produce a value for output parameter N based on a function (e.g., a kernel) programmed into, or accessed by (e.g., accessed via an API by), widget C. Widget C can transmit, via the communication channel 310, the value for output parameter N to widget B using one or more inter-widget signals. Widget B can subsequently produce a value for output parameter M based on the value for the input parameter N received from widget C.

In some embodiments, one or more input parameter value(s) and/or one or more output parameter value(s) (or tracking data derived from the parameter value(s)) can be used to cause an action. For example, an input parameter value(s) and/or an output parameter value(s) can be used to modify a behavior of a widget from the widgets 380. For example, a value for output parameter K produced at widget A based values for input parameters R and K can be used to change an advertisement displayed at widget A or execute a particular function (e.g., an algorithm) at widget A. Specifically, widget A can trigger display of an advertisement for a red truck of a particular brand and dealer based on an output parameter value produced by widget A. The output parameter value can be produced by widget A based on a location value received at widget A as an input parameter value. The location value received by widget A can be sent, using inter-widget signaling, from widget C as an output parameter value. The output parameter value from widget C can be produced based on information collected from a user based on an interaction of the user with widget C.

In some embodiments, an input parameter value(s) and/or an output parameter value(s) can be collected and/or stored as tracking data (e.g., widget tracking data). The tracking data can be stored locally in the memory 380 and/or at a remote location (e.g., at the channel host 300). The tracking data can be associated with one or more of the widgets 380, one or more of the content aggregation points 390, the network entity 330, a widget server (e.g., widget server 350), the channel host 300, and/or a user profile. In some embodiments, the tracking data can be further processed at the network entity 330 and/or at a remote location (e.g., at the channel host 300).

Each of the widgets 380 can be configured to discover a function associated with another widget using inter-widget signaling. Specifically, a widget from the widgets 380 can be configured to request (e.g., request using an inter-widget signal) information related to one or more input parameters that can be received/processed by and/or one or more output parameters produced by another widget from the widgets 380. Based on this information the widget can send an output parameter value (as an input parameter value to the other widget) or receive an input parameter value (transmitted as an output parameter value from the other widget).

In some embodiments, in response to a widget (such as widget A) being served to content aggregation point 320, the widget can be configured to register information (e.g., indicators) related to input/output parameter values that can be handled by the widget. The information can be stored in, for example, a portion of memory 380 where the information can be accessed by another widget. The registered information can then be accessed and used by another widget (such as widget B) to determine whether or not certain input/output parameter values can be exchanged with the widget. In some embodiments, the registered information can be stored at a globally accessible location outside of the network entity 330. For example, the input/output parameter values that can be handled by one or more of the widgets 380 can be stored at the channel host 300. In some embodiments, registration by a widget can be based on functionality available to the widget via an API. For example, a widget can indicate that it has the capability to receive specified input parameters and/or produce specified output parameters that are associated with a function that can be invoked based on an API.

In some embodiments, information related to input/output parameter values can be registered by the content aggregation point 320 and/or the network entity 330. In some embodiments, registration for one or more of the widgets 380 can be triggered in response to at least a portion of the communication channel 310 being established at content aggregation point 320. In some embodiments, registration for one or more of the widgets 380 can be triggered in response to the widget(s) joining the communication channel 310. In some embodiments, registration of input/output parameter values can be a prerequisite for permission to communicate via the communication channel 310. In some embodiments, one or more portions of the registration information can be restricted from one or more of the widgets 380 based on widget placement (e.g., a widget placement identifier (PID)), widget type, widget content, and/or an identifier associated with the widget(s) (e.g., a widget identifier (WID)).

In some embodiments, one or more of the widgets 380 can be configured to declare (e.g., send via a broadcast signal) input/output parameter values that can be handled by the widget(s). For example, widget A can declare (using inter-widget signaling) to widget B and widget C that widget A can handle values related to input parameters R, K, and L, and/or can declare to widget B and widget C that widget A can produce values related to output parameters J, K, and N. In some embodiments, widget A can send information related to a portion of input parameters and/or a portion of output parameters to less than all of the widgets 380 (e.g., only widget C).

In some embodiments, after a presence of a first widget from the widgets 380 has been determined by a second widget from the widgets 380 based on inter-widget signaling, the second widget can specifically query the first widget with respect to one or more input/output parameter values (e.g., a specific input parameter value). For example, widget A can determine that widget B exists and is available for inter-widget communication via inter-widget signaling. After determining the presence of widget B, widget A can query whether widget B can receive one or more specified input parameter values (as output parameter values from widget A) and/or can produce one or more specified output parameter values (as input parameter values for widget A). This type of exchange can be conducted based on a inter-widget signaling protocol. In other words, one of the widgets 380 can request information related to handling of input/output parameter values by another widget from the widgets 380.

In some embodiments, a widget (e.g., widget B) from the widgets 380 can be configured to, in response to an event, request, register, and/or transmit (e.g., declare) an indicator of (e.g., broadcast an indicator of) input/output parameter value(s) that can be handled. For example, one or more widgets 380 can be configured to broadcast an indicator of and/or re-register input/output values that can be handled by the widget(s) in response to receipt of a new function served from, for example, the channel host 300 and/or a widget server (e.g., widget server 360). For example, one or more functions (not shown) served to a widget in response to a request can trigger re-registration based on new functionality acquired by the widget through the function(s). In some embodiments, the event can be a user-triggered event such as a user request or a user input.

In some embodiments, one or more of the widgets 380 can be configured to regularly (e.g., periodically) and/or randomly, request, register and/or transmit (e.g., declare) indicators related to functionality. For example, one or more widgets 380 can be configured to broadcast whether or not they can receive one or more values related to an input parameter value and/or produce one or more values related to an output parameter value according to a periodic cycle (e.g., every second). In some embodiments, one or more widgets 380 can be configured to request information related to one or more values that can be received and/or produced by a widget from the widgets 380 according to a schedule.

In some embodiments, the widgets 380 can be configured to exchange input/output parameter values despite being configured to operate based on different protocols, platforms, and so forth. For example, widget A can be a java-based widget and widget B can be programmed based on a proprietary platform that is not compatible with java. However, widget A can be configured to compatibly exchange input/output parameter values with widget B by formatting the input/output parameter values based on a common protocol. The common protocol can be, for example, a inter-widget signaling protocol. In some embodiments, the widgets 380 can be configured to access a translation function so that they can compatibly interact as described in connection with FIG. 1.

Although FIG. 3 is related to inter-widget communication via communication channel 310, which is a communication channel established within content aggregation point 320, the embodiments described in connection with FIG. 3 can be applied within inter-widget communication via a different communication channel configuration. For example, the embodiments described in connection with FIG. 3 can be applied in connection with a communication channel established between multiple content aggregation points (which could be executing at one or more network entities) using one or more channel hosts (e.g., network entities). The network entities may be configured to operate based on different platforms (e.g., a personal computer platform vs. a PDA platform). Also, the concepts described in connection with the embodiments of FIG. 3 can be applied to many different types of parameters (e.g., formatting parameters, parameters related to physical placement within a content aggregation point, parameters related to the attributes of the communication channel, etc.).

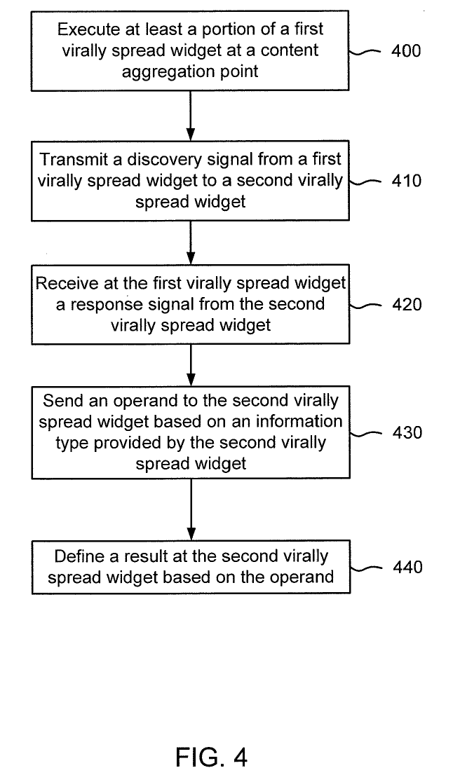

FIG. 4 is a flowchart that illustrates a method related to inter-widget signaling, according to an embodiment. As shown in FIG. 4, at least a portion of a first virally spread widget is executed at a content aggregation point. The virally spread widget can be executed in response to a reference to the widget being accessed at the content aggregation point. The widget can be shared with the content aggregation point from a different content aggregation point where an instance of the widget has been placed.

A discovery signal is transmitted from a first virally spread widget to a second virally spread widget at 410. The second virally spread widget can be associated with a different content aggregation point than the content aggregation point associated with the first virally spread widget. The first virally spread widget and the second virally spread widget can be executing at the same or different network entities. The discovery signal can be transmitted over a communication channel after at least a portion of the second virally spread widget has been executed. In some embodiments, the discovery signal can also be sent to a third virally spread widget. In some embodiments, the discovery signal can broadcast to several virally spread widgets listening to inter-widget signals transmitted over a communication channel.

A response signal from the second virally spread widget is received at the first virally spread widget at 420. The response signal can be transmitted via a communication channel established in response to a request from the first virally spread widget and/or the second virally spread widget. In some embodiments, the response signal can be broadcast to several virally spread widgets listening to inter-widget signals transmitted over a communication channel.

An operand is sent to the second virally spread widget based on an information type provided by the second virally spread widget at 430. In some embodiments, the operand can also be sent from the first virally spread widget to a third virally spread widget. In some embodiments, the operand can be broadcast to several virally spread widgets listening to inter-widget signals transmitted over a communication channel.

A result is defined at the second virally spread widget based on the operand at 440. In some embodiments, the result can be used to produce an image on a display associated with a network entity. In some embodiments, the result can be broadcast back to and used by the first virally spread, for example, to produce an image or calculate another result (e.g., a different result).

In one embodiment, a processor-readable medium storing code representing instructions to cause a processor to perform a process includes code to transmit using a communication channel a discovery signal from a first virally spread widget that has at least a portion executed at a content aggregation point to a second virally spread widget. The code also includes code to receive at the first virally spread widget a response signal sent from the second virally spread widget in response to the discovery signal.

In some embodiments, at least a portion of the second virally spread widget can be executing at the content aggregation point. In some embodiments, the content aggregation point can be a first content aggregation point associated with a first network entity and at least a portion of the second virally spread widget is executing at a second content aggregation point associated with second network entity. In some embodiments, the response signal can include an indicator of an information type provided by the second virally spread widget.

In some embodiments, the code includes code configured to transmit an operand from the first virally spread widget to the second virally spread widget. The operand can be defined based on an indicator of an information type provided by the second virally spread widget. The information type can be communicated using the response signal. The code can also include code to receive at the first virally spread widget a result from the second virally spread widget. The result can be defined at the second virally spread widget based on the operand.

In some embodiments, the transmitting can be performed in response to a reference to the first virally spread widget being accessed at the content aggregation point. The reference to the first virally spread widget can be associated with the content aggregation point in response to a placement request. In some embodiments, at least a portion of the code can be sent to the processor-readable medium from a widget host in response to the portion of the first widget being executed at the content aggregation point.

In some embodiments, the discovery signal can be a broadcast signal. In some embodiments, the discovery signal and the response signal can be defined based on a protocol associated with an application programming interface. In some embodiments, the transmitting can be performed after at least a portion of the second widget is executed at the content aggregation point.

In another embodiment, a method can include receiving an indicator that at least a portion of a first virally spread widget has been requested by a network entity for execution within a content aggregation point at the network entity. A set of functions can be sent to the network entity in response to the indicator. The set of functions can include a function configured to facilitate an interactive session between the first virally spread widget and a second virally spread widget requested for execution.

In some embodiments, the method can also include establishing a communication channel between the first virally spread widget and the second virally spread widget. At least one of the first virally spread widget or the second virally spread widget can be configured to send a discovery signal via the communication channel.

In some embodiments, the second virally spread widget can be requested by the network entity for execution within the content aggregation point. In some embodiments, the method can also include sending a signal to designate the first virally spread widget as a client-side master widget at the content aggregation point.

In some embodiments, the content aggregation point can be a first content aggregation point. The set of functions can include a sharing function configured to enable placement of the first virally spread widget at a second content aggregation point.

Some embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; and hardware devices that are specially configured to store and execute program code, such as Application-Specific Integrated Circuits (ASICs), Programmable Logic Devices (PLDs), and Read-Only Memory (ROM) and Random-Access Memory (RAM) devices. Examples of computer code include, but are not limited to, micro-code or micro-instructions, machine instructions, such as produced by a compiler, and files containing higher-level instructions that are executed by a computer using an interpreter. For example, embodiments may be implemented using Java, C++, or other object-oriented programming language and development tools. Additional examples of computer code include, but are not limited to, control signals, encrypted code, and compressed code.

In conclusion, among other things, methods and apparatus related to inter-widget communication have been described. While various embodiments have been described above, it should be understood that they have been presented by way of example only, and various changes in form and details may be made. For example, the embodiments described herein can include various combinations and/or sub-combinations of the functions, components and/or features of the different embodiments described. For example, although many of the embodiments were discussed in connection with an inter-widget communication session, the embodiments can be applied to any type of inter-widget interactive session.

What is claimed is:

1. A processor-readable medium storing code representing instructions that when executed by a processor cause the processor to:
perform a process includes code to transmit using a communication channel a discovery signal from a first virally spread widget having at least a portion executed at a content aggregation point to a second virally spread widget; and
receive at the first virally spread widget a response signal sent from the second virally spread widget in response to the discovery signal.

2. The processor-readable medium of claim 1, wherein at least a portion of the second virally spread widget is executing at the content aggregation point.

3. The processor-readable medium of claim 1, wherein the content aggregation point is a first content aggregation point associated with a first network entity and at least a portion of the second virally spread widget is executing at a second content aggregation point associated with second network entity.

4. The processor-readable medium of claim 1, wherein the response signal includes an indicator of an information type provided by the second virally spread widget.

5. The processor-readable medium of claim 1, further storing code representing instructions that when executed by the processor cause the processor to:
transmit an operand from the first virally spread widget to the second virally spread widget, the operand being defined based on an indicator of an information type provided by the second virally spread widget, the information type being communicated using the response signal; and
receive at the first virally spread widget a result from the second virally spread widget, the result being defined at the second virally spread widget based on the operand.

6. The processor-readable medium of claim 1, wherein the transmitting is performed in response to a reference to the first virally spread widget being accessed at the content aggregation point, the reference to the first virally spread widget is associated with the content aggregation point in response to a placement request.

7. The processor-readable medium of claim 1, wherein the at least a portion of the code is sent to the processor-readable medium from a widget host in response to the portion of the first widget being executed at the content aggregation point.

8. The processor-readable medium of claim 1, wherein the discovery signal is a broadcast signal.

9. The processor-readable medium of claim 1, wherein the discovery signal and the response signal is defined based on a protocol associated with an application programming interface.

10. The processor-readable medium of claim 1, wherein the transmitting is performed after at least a portion of the second widget is executed at the content aggregation point.

11. A method, comprising:
receiving an indicator that at least a portion of a first virally spread widget is requested by a network entity for execution within a content aggregation point at the network entity; and
sending a set of functions to the network entity in response to the indicator, the set of functions can include a function configured to facilitate an interactive session between the first virally spread widget and a second virally spread widget requested for execution.

12. The method of claim 11, further comprising:
establishing a communication channel between the first virally spread widget and the second virally spread widget, at least one of the first virally spread widget or the second virally spread widget being configured to send a discovery signal via the communication channel.

13. The method of claim 11, wherein the second virally spread widget is requested by the network entity for execution within the content aggregation point.

14. The method of claim 11, further comprising:
sending a signal to designate the first virally spread widget as a client-side master widget at the content aggregation point.

15. The method of claim 11, wherein the content aggregation point is a first content aggregation point, the set of functions includes a sharing function configured to enable placement of the first virally spread widget at a second content aggregation point.
